(19) United States
(12) Patent Application Publication
(10) Pub. No.: US 2019/0034841 A1
(43) Pub. Date: Jan. 31, 2019

(54) DETERMINING DIGITAL VALUE OF A DIGITAL TECHNOLOGY INITIATIVE

(71) Applicant: Accenture Global Solutions Limited, Dublin (IE)

(72) Inventors: Shobit Arora, Houston, TX (US); Christian Campagna, Kronberg im Taunus (DE); Aneel Delawalla, Atlanta, GA (US); Charles Wise, Alpharetta, GA (US)

(21) Appl. No.: 15/663,986

(22) Filed: Jul. 31, 2017

(51) Int. Cl. G06Q 10/06; G06Q 30/02

(52) U.S. Cl. CPC G06Q 10/067; G06Q 30/0201

(57) ABSTRACT

A computer-implemented method is described. The method includes a computing system accessing a technology database that includes multiple digital initiatives and data describing each initiative. For each digital initiative in a subset of initiatives: the system associates the digital initiative to an indicator for an operation that relates to the digital initiative. The system includes a technology assessment model and uses the model to determine one or more impact metrics based on the indicator and the data from the technology database. The one or more impact metrics each correspond to implementation of the digital initiative. A data visualization model of the system generates a data structure that is provided for output via a client device. The data structure includes the impact metrics and analytical data indicating a digital value that is obtainable based on implementation of the digital initiative.

### FIELD

The present specification is related to evaluation of digital technology.

### BACKGROUND

With the advent of digital technologies, more and more companies are implementing digital initiatives/technologies to drive greater revenues, reduce operational costs, and improve efficiencies across a variety of process flows. In general, prior to implementing a particular digital technology, a technical and operational use case may be created. However, processes for generating certain use cases for implementing a particular digital technology might not include quantifying one or more benefits that are obtainable from the technology. Further, processes for generating a use case for a digital technology might not include analytical data that links a digital initiative to at least one economic benefit to be gained from executing the digital initiative.

### SUMMARY

This specification describes systems and methods for quantifying the operational and commercial impact of digital technology. A computing system accesses a technology database that includes multiple digital technology initiatives and data describing each initiative. For each digital initiative in a subset of initiatives: the system associates the digital initiative to an indicator for an operation that relates to the initiative. The system includes a technology assessment model and uses the model to determine impact metrics based on the indicator and the data from the technology database.

Impact metrics can each correspond to implementation of the digital initiative. In particular, an impact metric can indicate how operational efficiencies can be enhanced or otherwise modified in view of data indicated by the impact metric. A visualization model of the system generates a data structure and the system provides the data structure for output via a client device. The data structure can include the impact metrics and a graphical representation of analytical data indicating a digital value that is obtainable based on implementation of the digital initiative.

One aspect of the subject matter described in this specification can be embodied in a computer-implemented method. The method includes, accessing, by a computing system, a technology database that includes multiple digital initiatives and data describing each digital initiative of the multiple digital initiatives; for each digital initiative in a subset of digital initiatives: associating, by the computing system, the digital initiative to an indicator for an operation that relates to the digital initiative; and determining, by a technology assessment model of the computing system, one or more impact metrics based on the indicator and the data from the technology database that describes the digital initiative, the one or more impact metrics each corresponding to implementation of the digital initiative. The method further includes, generating, by a data visualization model of the computing system, a data structure that is provided for output via a client device, the data structure including the one or more impact metrics and analytical data relating to implementation of the digital initiative.

These and other implementations can each optionally include one or more of the following features. For example, in some implementations, the method further includes: determining, by the technology assessment model and based on execution of impact assessment logic, analytical data for implementing the digital initiative, wherein the analytical data comprises one or more of: data indicating a digital value add to be realized from adjusting an attribute of the digital initiative; or data indicating the digital value add to be realized from initially implementing the digital initiative.

In some implementations, determining the one or more impact metrics, includes: executing, by the technology assessment model, one or more processes using data about the operation that relates to the digital initiative; in response to executing, generating, by the technology assessment model, results data that quantifies an outcome of adjusting an attribute of the digital initiative; and determining, by the technology assessment model, at least one impact metric based on the results data.

In some implementations, the indicator is a key performance indicator for the operation, and at least one impact metric of the one or more impact metrics indicates an operational impact to the operation that occurs from adjusting the attribute of the digital initiative. In some implementations, at least one impact metric of the one or more impact metrics indicates a cost of adjusting the attribute of the digital initiative, the cost corresponding to a digital value that is obtainable by adjusting the attribute of the digital initiative.

In some implementations, the attribute of the digital initiative is an implementation maturity of the digital initiative, where the implementation maturity corresponds to an amount of digital value that is a realized from using the digital initiative. In some implementations, generating the data structure includes: generating mapping data that includes a prioritized listing of each digital initiative in the subset of digital initiatives, where each digital initiative is prioritized in the listing using a parameter value of at least one impact metric of the digital initiative.

In some implementations, prioritization of each digital initiative is based on one or more of: i) a commercial impact of adjusting the attribute of the digital initiative, the commercial impact being indicated by the parameter value; ii) a magnitude of organizational change from adjusting the attribute of the digital initiative, the magnitude being indicated by the parameter value; or iii) a complexity of adjusting the attribute of the digital initiative, the complexity being indicated by the parameter value. In some implementations, data from the technology database includes: a listing of multiple digital initiatives in a digital library of initiatives; and data from case studies about digital value adds that were realized from adjusting attributes of each digital initiative in the digital library of initiatives.

Other implementations of the above and other aspects include corresponding systems, apparatus, and computer programs, configured to perform the actions of the methods, encoded on computer storage devices. An electronic system of one or more computers can be so configured by virtue of software, firmware, hardware, or a combination of them installed on the electronic system that in operation cause the system to perform the actions. One or more computer programs can be so configured by virtue of having instructions that, when executed by data processing apparatus, cause the apparatus to perform the actions.

The subject matter described in this specification can be implemented in particular implementations and can result in one or more of the following advantages. The described subject matter can be implemented to quantify an operational and commercial impact of digital technologies. For example, before implementing a particular digital technology, processes of this specification can be used to efficiently generate analytics data for creating a technology use case for initially adopting a digital initiative or for modifying an implementation attribute of a current digital initiative.

Entities may experience operational deficiencies based on inefficient use of computing resources when implementing or performing certain operational processes. The described teachings can enable an entity's electronic systems to realize computing efficiencies, such as increased system throughput and reduced processor utilization. Efficiencies can be realized by identifying performance indicators for an operation, linking the indicators to a digital technology, and performing computations for determining a digital value add of the technology. Results of the computations can provide support for adopting, or adjusting performance of, a digital initiative such that operational, economic, and computing efficiencies can be realized.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 illustrates a block diagram of an example computing system for determining a digital value of a digital technology initiative.

FIG. 2 illustrates a flow diagram of an example process for determining an impact of adjusting a maturity attribute of a digital technology initiative.

FIG. 3 illustrates a diagram showing data associated with a current state digital maturity and a future state impact of adjusting a maturity attribute of a digital technology initiative.

FIG. 4 illustrates a diagram that includes analytical algorithms for determining a digital value of a digital technology initiative.

FIG. 5 illustrates a flow diagram of an example process for determining a digital value of a digital technology initiative.

FIG. 6 is a block diagram of a computing system that can be used in connection with computer-implemented methods described in this specification.

Like reference numbers and designations in the various drawings indicate like elements.

### DETAILED DESCRIPTION

This specification describes systems and methods for quantifying an operational and commercial impact of digital technology. For example, prior to implementing a particular digital technology, the described methods can be used to create a technology use case for initially adopting a digital initiative or for modifying an implementation attribute of a current digital initiative.

The technology use case can include quantification of an overall benefit(s) for implementing a particular digital imitative or modifying a manner in which a current initiative is being utilized or executed. The technology use case can include an implementation roadmap with detailed level data that indicates a formal linkage between the technology initiative and an operational or commercial benefit that is obtainable upon implementation of the roadmap.

In this context, the described subject matter provides an integrated framework that can be used to quantify the operational impact of implementing or adjusting an implementation attribute of certain digital technologies. The framework can be implemented to provide a link between the technology and a prospective pecuniary benefit that can be gleaned from using the technology in a more efficient or mature manner.

For example, one or more computing models of the described systems can be used in operational scenarios where an entity desires to better understand a quantifiable impact of adopting a new digital initiative or improving a process maturity of an existing initiative. Hence, the described processes can be used during development activities to provide a directional indicator as to which technologies will directionally provide the greatest operational and/or commercial impact for a public or private entity.

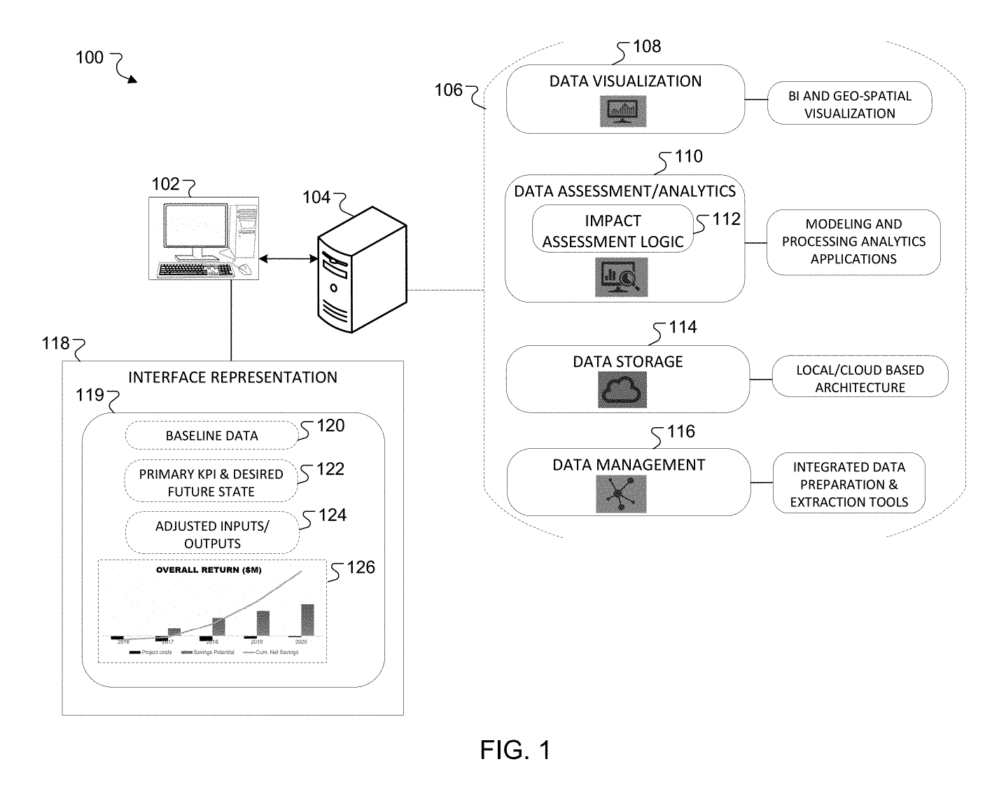

FIG. 1 illustrates a block diagram of an example computing system 100 for determining a digital value of a digital technology initiative. System 100 generally includes user device 102 and computing server 104. As shown in FIG. 1, user device 108 can correspond to an example computing console that includes a keyboard and monitor for receiving user input. In some implementations, user device 102 can be one of a variety of computing devices, such as laptop/desktop computers, digital streaming content devices, smart televisions, electronic book/reader devices, gaming consoles, electronic wearable devices, tablet devices or other related computing devices.

Server 104 includes computing modules 106 that can be used by system 100 to execute one or more computational functions related to visualizing data structures, performing analytical assessments on data accessible from a data storage device, and managing or preparing data for analysis and visualization. As described below, system 100 can also use server 104 to generate a data structure as well as an example interface representation that includes the data structure.

Server 104 includes a data visualization module 108, a data analytics module 110, a data storage device/module 114, and a data management module 116. In some implementations, modules 106 are each collectively or individually included in, or accessible by, server 104. Additionally, the described functional and computational processes of modules 106 can be enabled by computing logic or programmed instructions executable by processors and memory associated with server 104. In some implementations, computing functions or processes of server 104 can be executed in an example cloud-based computing environment.

Server 104 can include one or more processors, memory, and data storage devices (e.g., data storage device 114) that collectively form one or more computing systems of server 104. The processors of the computing systems process instructions for execution by server 104, including instructions stored in the memory or on the storage device to display graphical information for a graphical user interface (GUI) via an example display of user device 102. In some implementations, execution of the stored instructions can cause one or more of the actions described herein to be performed by server 104 or user device 102.

In other implementations, multiple processors may be used, as appropriate, along with multiple memories and types of memory. For example, server 104 may be connected with multiple other computing devices, with each device (e.g., a server bank, groups of servers, modules, or a multi-processor system) performing portions of the actions or operations associated with the various processes or logical flows described in this specification.

Referring again to FIG. 1, data storage device/module 114 can include a variety of data relating to multiple digital initiatives or digital technology initiatives. For example, module 114 can be an example storage device that stores a technology database. The database can include a listing of multiple digital technology initiatives that form a digital library of initiatives. In some implementations, a storage device of module 114 can include data relating to case studies about implementation details for certain digital technologies. The implementation details can correspond to additions in terms of digital value (digital value adds) that can be gained from a particular digital initiative.

For example, a digital technology in the digital library of initiatives can include data for a telematics and vehicle tracking system of a luxury car. A digital technology or initiative can include use of a vehicle's telematics and tracking system to track the vehicle's location. However, case study data can indicate alternative uses for the system's telematics functions such that a vehicle's on-board data transmission rates can be improved. Hence, at least one digital value add can be obtained by adjusting an attribute or technical feature of how a telematics digital initiative is implemented within a vehicle's on-board systems.

In some implementations, the digital library of technology initiatives can be stored within an example device such as a computing resource(s) configured to store large amounts of data (e.g., large datasets exceeding 5 terabytes (TB) or more). Example computing resources for data storage can include various electronic devices that use electrical power to store and retrieve data. The data can be stored in either an analog format or a digital format and can be stored on a variety of media. Example devices can include hard drives, server based storage devices, or cloud storage systems including multiple distinct devices.

Data visualization module 108 can include computing models and other software for combining geographic information system (GIS) and business intelligence (BI) technologies. For example, module 108 can execute one or more geospatial BI computing processes. The processes can combine spatial analysis and data visualization with BI applications of server 104. In some implementations, execution of these processes enables improved data analysis processes that aid corporate entities with making more informed decisions about certain digital initiatives.

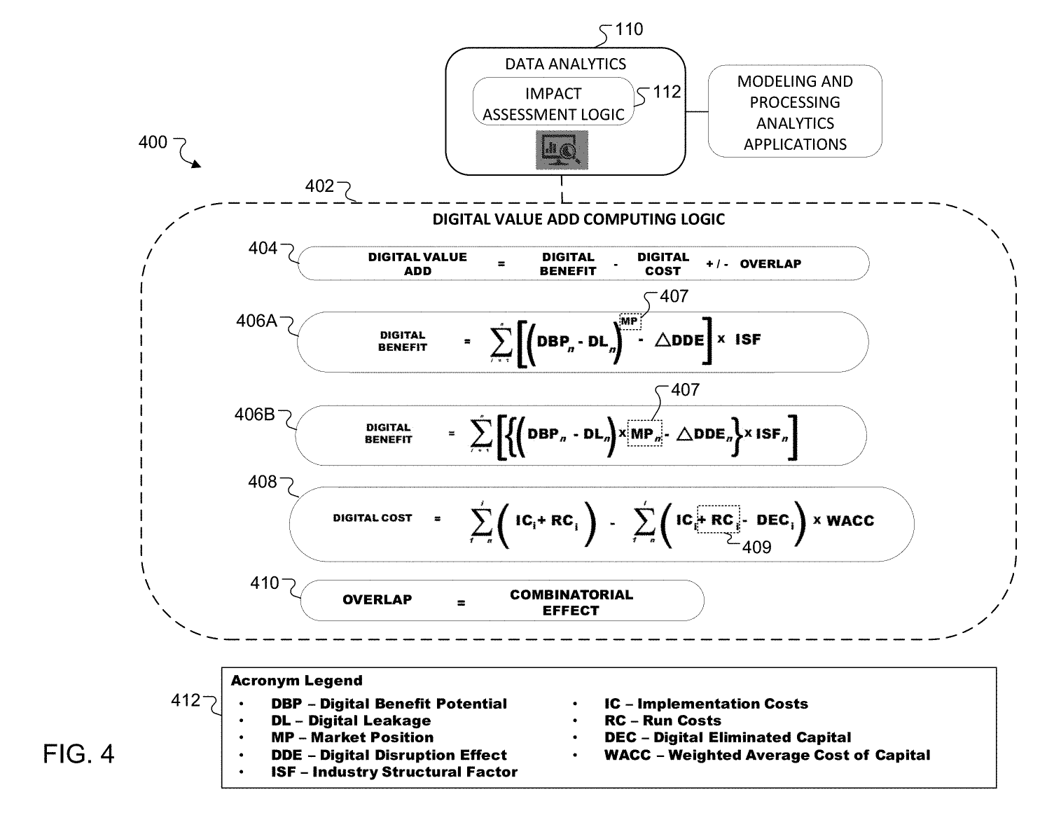

Data analytics module 110 can include computing logic for implementing data assessment and analytics models of system 100. For example, module 110 can be configured to execute software instructions for performing data modeling and processing functions. The modeling and processing functions can be associated with at least one analytics application of server 104. In some implementations, module 110 includes a technology assessment model that executes one or more impact assessment algorithms 112 for determining a digital value add associated with a particular digital initiative (described below referencing FIG. 4).

Data management module 116 can execute software instructions for one or more data preparation and extraction tools. In some implementations, data management tools can be integrated such that accessed or received data can be analyzed, extracted, and prepared, or otherwise formatted, for presentation to a user via an example client device such as, user device 102. For example, server 104 can access analytical case study data for the telematics system from storage device 114 and use module 116 to extract and format the study data such that a data structure can be generated for output via user device 102.

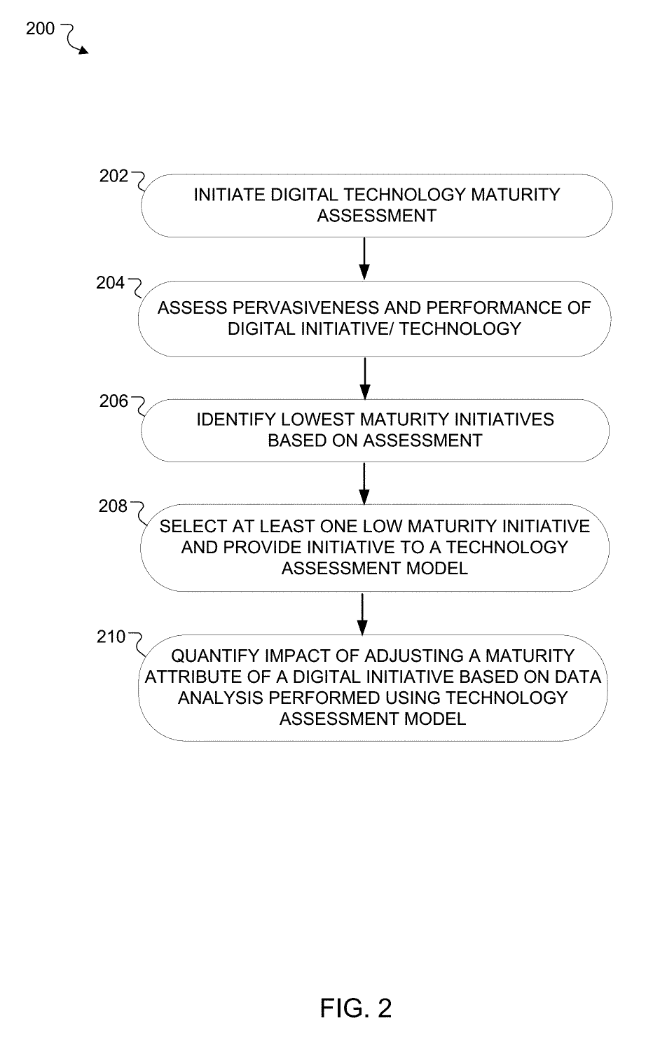

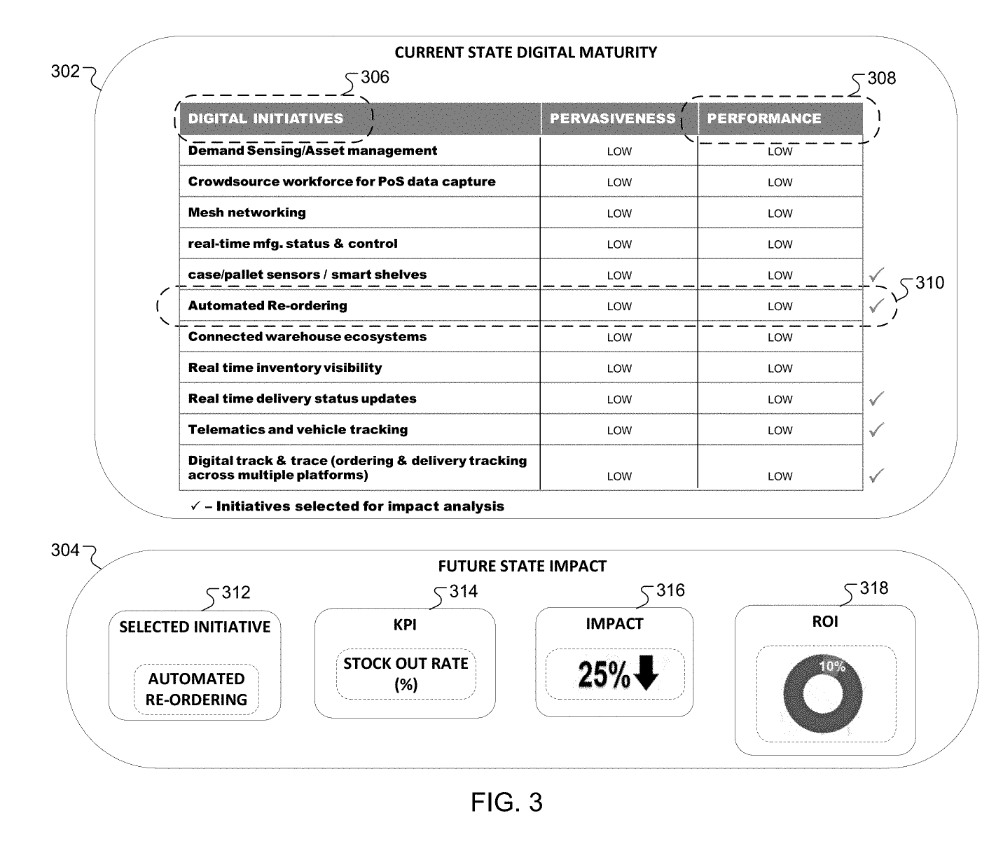

System 100 can use modules 106 to generate an example interface representation 118. As shown, interface 118 can use a data structure 119 for presenting baseline data 120, operational data 122, adjustable data 124, analytics data 126. Each of these data features are described in more detail below with reference to FIG. 2 and FIG. 3. Also, one or more of these data features can be included in data structure 119 generated by system 100. In some implementations, a representation of interface 118 forms a data structure 119 that can be provided for output to a user via a display or monitor/screen of user device 102.

FIG. 2 illustrates a flow diagram of an example process 200 for determining an impact of adjusting an attribute of a digital technology initiative. Process 200 can be implemented using system 100 described above. Thus, descriptions of process 200 may reference one or more of the above-mentioned modules or computational devices of system 200. In some implementations, described actions for implementing process 200 are enabled by computing logic executable by a processor and memory of user device 102 or server 104.

As indicated above, processes of this specification can be used to create a technology use case for initially adopting a digital initiative or for modifying an implementation attribute of a current digital initiative. The technology use case can include quantification of an impact of adjusting the attribute of the digital initiative, where the impact can indicate a benefit(s) or digital value add(s) that can be realized from adjusting the attribute. In some implementations, adjusting an attribute of the digital initiative corresponds to modifying a manner in which a current or baseline digital technology is being used or executed by a particular entity.

Referring to process 200, at block 202 system 100 is used to initiate a digital technology maturity assessment. Initiating a maturity assessment of a digital initiative can include performing a client interview to determine one or more types of technology applications that a client is currently using or plans to use in the future. In some implementations, determining a type technology application that a client is using includes accessing the library of digital initiatives stored in module 114 and identifying a subset of digital initiatives in the library.

Each digital initiative in the subset may be used by the client or entity to perform one or more operations. For example, a corporate entity may be using a particular digital technology for an inventory management system that runs computing software for execution of automated re-ordering. In some implementations, initiating a maturity assessment includes determining baseline data 120, where the baseline data includes metrics about a client's operational and commercial baseline for a particular digital initiative.

Initiating a maturity assessment of a digital initiative/technology may further include defining a scope of the assessment, where the scope can include assessing the maturity of multiple digital initiatives in the subset. Further, the assessment scope can include analyzing functions, process areas, or value chain components that overlap with technical aspects of the digital initiative.

During initial maturity assessment, system 100 can associate or link a digital initiative to an indicator for an operation that relates to the digital initiative. For example, automated re-ordering can include an inventory analysis operation that relates to use of the digital technology. The analysis operation can include determining a stock-out rate for ensuring proper inventory levels/management.

An indicator for the stock-out rate can be linked to the digital technology for automated re-ordering. The operation and/or the indicator for the operation can be used to determine impact data that corresponds to implementation of the digital initiative for automated re-ordering. In some implementations, the indicator is a key performance indicator (KPI) for the operation and the impact data includes metrics that indicate an operational impact to the operation that occurs from adjusting an attribute of the digital initiative.

As used herein, a KPI is a measurable parameter value that demonstrates how effectively an entity is achieving one or more key technical or operational objectives. For example, an entity can utilize KPIs to evaluate the entity's success at reaching targets or the effectiveness or maturity of certain technologies/technical processes for achieving the targets.

At block 204, process 200 includes assessing the pervasiveness and performance of at least one digital initiative in the subset, e.g., the initiative for executing inventory management processes related to automated re-ordering. Assessing the pervasiveness and performance can include conducting user interviews and performing computational analysis. The computational analysis can include computer based surveys that seek to evaluate and better understand the technical maturity of, for example, technology used for accomplishing automated re-ordering. In some instances, computational analysis can be performed using data collection and data management models of modules 106 (e.g., 9Lenses software application).

At block 206, system 100 can identify one or more lowest maturity initiatives from among the subset of digital initiatives and based on the assessment of the pervasiveness and performance of the digital technologies in the subset. For example, the digital technology for automated re-ordering may be identified as a low maturity initiative among other digital technologies in the subset. At block 208, process 200 includes selecting at least one low maturity initiative and providing data about the digital initiative to a technology assessment model of module 110.

In some implementations, data about the automated re-ordering digital initiative that is provided to the technology assessment model includes data gathered during assessment of the pervasiveness and performance of the initiative. In some instances, data about the automated re-ordering digital initiative includes case study data or other analytical insights. The case study data and insights can indicate how technical aspects of automated re-ordering can be better utilized to achieve greater digital value. For example, greater digital value may be achieved based on more efficient execution of operational processes for inventory management.

For certain operations and processes that are executed using low maturity digital initiatives, improved efficiencies can be realized by adjusting an attribute of the low maturity initiative. Hence, at block 206 of process 200, system 100 quantifies an impact of adjusting an attribute of a digital initiative based on data analysis performed using the technology assessment model of module 110. The attribute of the digital initiative that is adjusted can be the implementation maturity of the digital initiative.

For example, automated ordering can have a first maturity attribute that corresponds to low maturity and adjusting a maturity attribute of the initiative can include causing the maturity attribute to: i) change from low maturity to medium maturity; ii) change from low maturity to high maturity; or iii) change from medium maturity to high maturity. For automated re-ordering or other digital initiatives, a maturity attribute of the digital technology can be changed by modifying a manner in which the technology is being used or executed by a particular entity.

FIG. 3 illustrates a diagram showing data associated with a current state digital maturity 302 and a future state impact 304 of adjusting a maturity attribute of a digital technology initiative. Current state 302 includes a digital initiatives listing 306, performance attribute data 308, and an example digital initiative/technology 310. As shown, listings 306 can include a variety of digital technology initiatives. For example, listings 306 can include technology initiatives for demand sensing/asset management, real-time delivery status updates, telematics and vehicle tracking, and automated re-ordering. Performance attribute 308 can also correspond to a maturity attribute of a digital initiative.

Future state impact 304 can include a selected digital initiative 312, a KPI 314, a first impact metric 316, and a second impact metric 318. The selected digital initiative can be automated re-ordering. First and second impact metrics 316 and 318 can be example metrics that correspond respectively to operational and pecuniary impacts of adjusting an attribute of a digital initiative for automated re-ordering. Second impact 318 can be represented as a parameter value for return on investment (ROI), where the value corresponds to a pecuniary impact of adjusting the attribute.

Performance attribute 308 (e.g., implementation maturity) for automated re-ordering, or another digital initiative, can correspond to an amount of digital value that is realized from using the initiative. In some implementations, operational data 122 mentioned above can include KPI 314 (e.g., a primary KPI) and data relating to a desired future state, where the desired future state includes desired parameter values for KPI 314 and at least one impact metric.

In one implementation, digital technology 310 for automated re-ordering can have a low performance attribute 308 thereby leading to a high stock-out rate. A particular entity can conduct an assessment session to determine a desired level of impact. Operational data 122 can be produced to indicate a primary KPI 314 (e.g., stock-out rate) and a desired operational improvement for the primary KPI (e.g., stock-out rate lowered to 25%).

In some implementations, future state 304 can include data that shows a summary of desired impacts by digital initiative for each operational KPI 314. Future state 304 can include desired impacts that can be scaled up or scaled down based on combinatorial effects and adjustable inputs/outputs data 124. In some instances, achieving greater impacts generally corresponds to a greater work scope and a greater commercial cost for implementing a new digital initiative or for adjusting implementation attributes of existing digital initiatives.

FIG. 4 illustrates a diagram 400 that includes analytical algorithms 402 for determining a digital value add of a digital technology initiative. Algorithms 402 can be used by system 100 upon execution of impact assessment logic 112. Algorithms 402 include a computational process/formula 404 for determining a digital value add, computational processes 406A/B for determining a digital benefit, a computational process 408 for determining a digital cost, and an overlap variable that can correspond to combinatorial effects.

In some implementations, when determining digital cost, a variable 409 (“RC”) relating to run costs (described below) is optional and, thus, may be excluded from computational process 408. Further, in other implementations, and as shown in FIG. 4, when determining digital benefit, variable 407 (“MP”) relating to market position (described below) can be utilized as an exponential in computational process 406A or as a multiplication operand in computational process 406B.

Diagram 400 further includes a legend 412 that defines the variable names/acronyms for each of computational process 404, 406, and 408. Regarding variables of formula 406 and 408, digital benefit potential can include new sources of digital revenue, digitally driven increases in current revenue, and cost benefits from the reduction in human or computing middleware. Digital Leakage can represent unrealized digital potential related to technology implementation challenges, change management, organizational culture, etc.

Market Position can refer to whether the client is a first mover, a fast follower, or a laggard in adopting a particular new technology. Digital Disruption Effect can encompass negative impacts to current operations such as cannibalization of one or more existing sales channels. Industry Structural Factor can encompass variables that ultimately impact the digital benefits potential due to industry maturity, relevance of a digital technology, adoption rates of a digital initiative, etc.

Implementation Cost can include one-time expenditures for implementing one or more digital technology initiatives. Run Costs can include on-going expenditures for maintaining and servicing one or more digital initiative that are currently implemented. Digitally Eliminated Capital can represent a net reduction in on-going capital requirements for a new digital model. Combinatorial Effect can represent a net increase or a net decrease in total digital value added from a combination of multiple digital initiatives as well as the interplay between the combined digital initiatives.

In some implementations, determining a combinatorial effect can include analyzing effects data, where the effects data is based on combining two or more types of data stored in data storage device 114. Example effects data can include case study data and other data about how each of the combined digital initiatives can be implemented by a particular entity.

Impact assessment logic 112 can be executed by an example technology assessment model of module 110 to determine impact metrics or a digital value add of a digital initiative. In some implementations, executing impact assessment logic 112 causes module 110 to generate results data for quantifying an outcome of adjusting an attribute of the digital initiative. In some implementations, module 110 uses the technology assessment model to determine at least one impact metric based on the results data.

For example, with reference to automated re-ordering, module 110 can generate numerical results or impact metrics that indicate initial implementation of a digital technology for automated re-ordering can cause a 25% drop in a primary KPI that is an indicator for stock-out rate. Similarly, module 110 can also generate numerical results that indicate adjusting a maturity or performance attribute of the technology for automated re-ordering can cause a 10% increase in commercial gains that correspond to returns on investments.

Results data generated by system 100 can be an example parameter that indicates a computed digital value add determined using computational process 404. Parameters for digital value add computations can correspond to an impact metric for a future state commercial impact. For example, an impact metric can indicate a future state commercial impact, or added digital value, such as an overall return on investments in dollar amounts. The dollar amounts for the added digital value can be obtained or realized by initially implementing digital initiatives for automated re-ordering or by adjusting the performance (e.g., from low performance to high performance) of existing technology for automated re-ordering.

Computational process 404 of impact assessment logic 112 can be used to determine a commercial impact of digital interventions or a digital value add for an entity. For example, a digital value add can be calculated for an entire commercial entity, a specific corporate unit, a professional function, or entity geography. In some instances, a digital value add is calculated for a single period of time. As such, in order to determine long term impacts or impact trends of a particular digital initiative, a digital value add can be calculated for multiple time periods.

Furthermore, to assess digital value add from multiple digital interventions, a net present value (NPV) of the digital value add can be used to provide an “all in” impact from digital interventions. This “all in” impact can indicate projected digital value add to be gain over a particular time period (e.g., over 5 years) for multiple digital initiatives/interventions. In some implementations, each variable or component of the digital value add formula (e.g., computational process 404) can be further decomposed and assessed based on entity specific inputs and scope.

As described above, system 100 uses one or more modules of server 104 to generate a data structure 119 for displaying analytical data 126. Data 126 can relate to implementation of an example digital initiative, such as automated re-ordering. In some implementations, system 100 determines analytical data 126 based on analysis and computations performed using at least impact assessment logic 112 of module 110. System 100 can use data visualization module 108 to execute computing functions for generating one or more visuals of graphical data included with analytical data 126.

Analytical data 126 can include one or more of: i) data that indicates a digital value add to be realized from adjusting an attribute of a digital initiative; or ii) data that indicates a digital value add to be realized from initially implementing a digital initiative. For example, the data can include graphical data such as, bubble charts, or other visual data, indicating projected costs, commercial savings potentials, and cumulative net savings that are obtainable from implementing a digital initiative or from adjusting performance of a digital initiative.

The data can further include technical roadmaps that are based on computed impact metrics for quantifying complexity and magnitude/degree of organizational change from implementing, or adjusting performance of, a digital initiative. Roadmaps and other analysis data can be used to develop a technology use case containing detailed level data. The detailed data can show formal linkages between technology initiatives and operational or commercial benefits that are obtainable upon execution of the use case for the digital technology initiatives.

Generating data structure 119 includes generating mapping data that includes a prioritized listing of each digital technology initiative in a set of multiple digital initiatives. In some implementations, each digital initiative is prioritized in the listing using a parameter value of at least one impact metric for implementation of a digital initiative. For example, parameter values can indicate dollar amounts for added digital value that can be obtained by implementing, or adjusting implementation of, a digital initiative. Hence, the digital initiative can be prioritized such that digital initiatives with higher return dollar amounts receive higher prioritization.

In some implementations, prioritization of each digital initiative is based on one or more of: i) a commercial impact of implementing, or adjusting performance of, a digital initiative, where the commercial impact is indicated by a parameter value of an impact metric (e.g., return in dollar amounts); ii) a magnitude of organizational change from implementing, or adjusting performance of, a digital initiative, where the magnitude is indicated by the parameter value; or iii) a complexity of implementing, or adjusting performance of, the digital initiative, the complexity being indicated by the parameter value.

For example, magnitudes of organizational change can correspond to a parameter value of 0.9 that indicates a high magnitude of organizational change, a parameter value of 0.7 that indicates a medium magnitude of organizational change, or a parameter value of 0.3 that indicates a low magnitude of organizational change. Likewise, complexity of implementing, or adjusting performance of, a digital initiative can correspond to a parameter value of 0.9 that indicates high complexity, a parameter value of 0.7 that indicates medium complexity, or a parameter value of 0.3 that indicates low complexity.

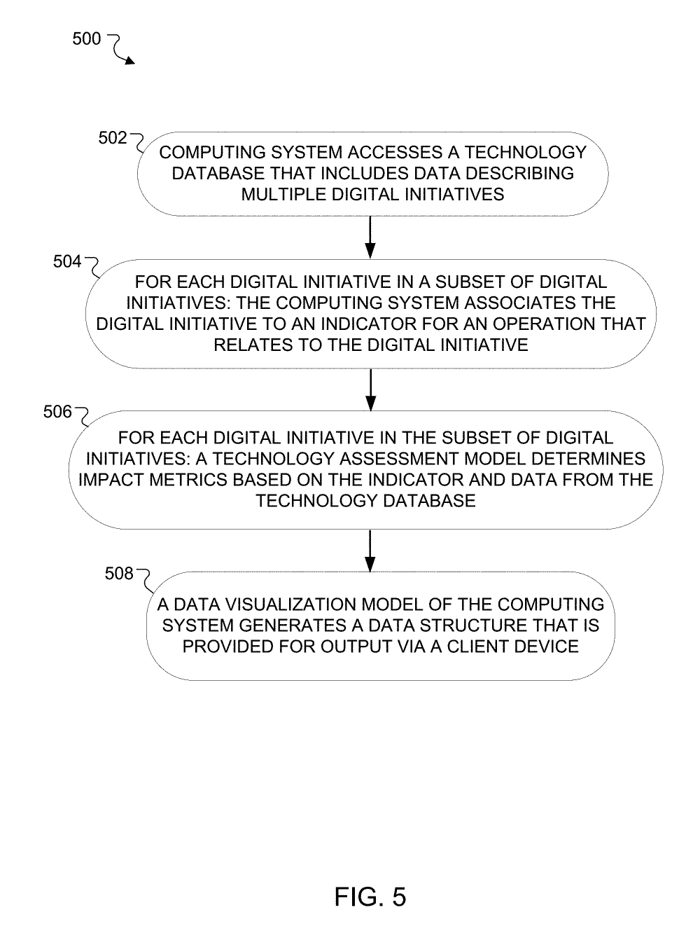

FIG. 5 illustrates a flow diagram of an example process 500 for determining a digital value of a digital technology initiative. Process 500 can be implemented using system 100 described above. Thus, descriptions of process 500 may reference one or more of the above-mentioned modules or computational devices of system 100. In some implementations, described actions for implementing process 500 are enabled by computing logic or software instructions executable by a processor and memory of user device 102 or server 104 described above.

At block 502 of process 500, a system 100 accesses a technology database that includes data describing multiple digital initiatives. As noted above, data from the technology database can include a listing of multiple digital initiatives in a digital library of initiatives and data from case studies about digital value adds that were realized from adjusting attributes of a particular digital initiative in the digital library of initiatives.

At block 504, for each digital initiative in a subset of digital initiatives, system 100 associates or links the digital initiative to an indicator for an operation that relates to the digital initiative. In some implementations, the indicator is a key performance indicator (KPI) for the operation, where the KPI relates to a measurable parameter value that demonstrates how effectively, or efficiently, a particular entity is achieving one or more key technical or operational objectives.

At block 506, for each digital initiative in the subset of digital initiatives, process 500 includes a technology assessment model of system 100 determining one or more impact metrics based on the indicator and the data from the technology database. The one or more impact metrics can each correspond to implementation of the digital initiative. In some implementations, determining the impact metrics includes the technology assessment model of module 110 executing impact assessment logic 112.

In response to executing logic 112, the technology assessment model generates results data that quantifies an outcome of adjusting an attribute of the digital initiative. In some implementations, the technology assessment model determines at least one impact metric based on the results data. For example, logic 112 can include computational processes that are associated with algorithms 402. Logic 112 can use data about the operation that relates to the digital initiative to execute computational processes of the algorithms to determine the impact metrics.

At block 508 of process 500, a data visualization model of the computing system generates a data structure that is provided for output via a client device (e.g., user device 102). The data structure can include the one or more impact metrics and analytical data that relates to implementation of the digital initiative. The impact metrics relate to impact data that indicate an operational or commercial impact to the operation that can occur from adjusting an attribute of the digital initiative.

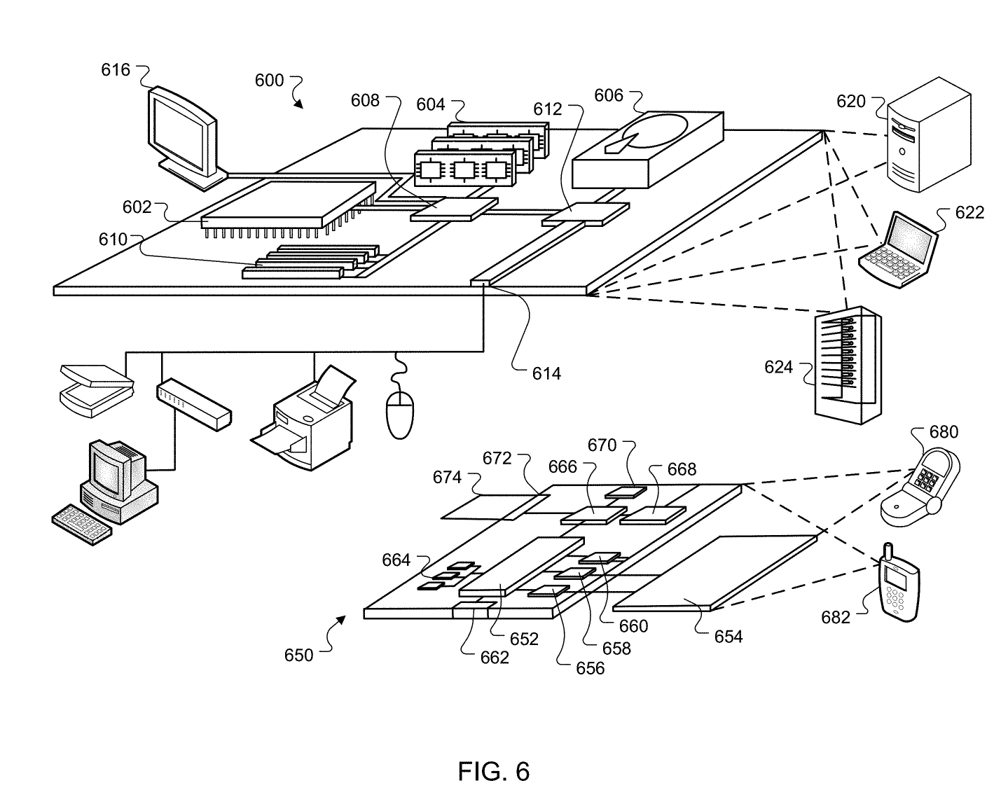

FIG. 6 is a block diagram of computing devices 600, 650 that may be used to implement the systems and methods described in this document, either as a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a computer-readable medium. In one implementation, the memory 604 is a volatile memory unit or units. In another implementation, the memory 604 is a non-volatile memory unit or units.

The storage device 606 is capable of providing mass storage for the computing device 600. In one implementation, the storage device 606 is a computer-readable medium. In various different implementations, the storage device 606 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high-speed controller 608 manages bandwidth-intensive operations for the computing device 600, while the low speed controller 612 manages lower bandwidth-intensive operations. Such allocation of duties is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In one implementation, the memory 664 is a computer-readable medium. In one implementation, the memory 664 is a volatile memory unit or units. In another implementation, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provided as a security module for device 650, and may be programmed with instructions that permit secure use of device 650. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs, computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs, also known as programs, software, software applications or code, include machine instructions for a programmable processor, and can be implemented in a high-level procedural and/or object-oriented programming language, and/or in assembly/machine language. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, the term “module” is intended to include, but is not limited to, one or more computers/computing devices configured to execute software instructions that include program code that causes a processing unit(s) of the computing device to execute one or more functions. The term “computer” is intended to include any data processing or computing devices/systems, such as a desktop computer, a laptop computer, a mainframe computer, a personal digital assistant, a server, a handheld device, or any other device able to process data.

As used herein, the terms “machine-readable medium” “computer-readable medium” refers to any computer program product, apparatus and/or device, e.g., magnetic discs, optical disks, memory, Programmable Logic Devices (PLDs) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component such as an application server, or that includes a front end component such as a client computer having a graphical user interface or a Web browser through which a user can interact with an implementation of the systems and techniques described here, or any combination of such back end, middleware, or front end components. The components of the system can be interconnected by any form or medium of digital data communication such as, a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed.

For example, in some embodiments, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

A number of embodiments have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method, comprising:
accessing, by a computing system, a technology database that includes multiple digital initiatives and data describing each digital initiative of the multiple digital initiatives;
for each digital initiative in a subset of digital initiatives:
associating, by the computing system, the digital initiative to an indicator for an operation that relates to the digital initiative; and
determining, by a technology assessment model of the computing system, one or more impact metrics based on the indicator and the data from the technology database that describes the digital initiative, the one or more impact metrics each corresponding to implementation of the digital initiative; and
generating, by a data visualization model of the computing system, a data structure that is provided for output via a client device, the data structure including the one or more impact metrics and analytical data relating to implementation of the digital initiative.

2. The method of claim 1, further comprising:
determining, by the technology assessment model and based on execution of impact assessment logic, analytical data for implementing the digital initiative, wherein the analytical data comprises one or more of:
data indicating a digital value add to be realized from adjusting an attribute of the digital initiative; or
data indicating the digital value add to be realized from initially implementing the digital initiative.

3. The method of claim 1, wherein determining the one or more impact metrics, comprises:
executing, by the technology assessment model, one or more computational processes using data about the operation that relates to the digital initiative;
in response to executing, generating, by the technology assessment model, results data that quantifies an outcome of adjusting an attribute of the digital initiative; and
determining, by the technology assessment model, at least one impact metric based on the results data.

4. The method of claim 3, wherein:
the indicator is a key performance indicator for the operation, and
at least one impact metric of the one or more impact metrics indicates an operational impact to the operation that occurs from adjusting the attribute of the digital initiative.

5. The method of claim 3, wherein at least one impact metric of the one or more impact metrics indicates a cost of adjusting the attribute of the digital initiative, the cost corresponding to a digital value that is obtainable by adjusting the attribute of the digital initiative.

6. The method of claim 3, wherein the attribute of the digital initiative is an implementation maturity of the digital initiative, where the implementation maturity corresponds to an amount of digital value that is a realized from using the digital initiative.

7. The method of claim 3, wherein generating the data structure comprises:
generating mapping data that includes a prioritized listing of each digital initiative in the subset of digital initiatives, where each digital initiative is prioritized in the listing using a parameter value of at least one impact metric of the digital initiative.

8. The method of claim 6, wherein prioritization of each digital initiative is based on one or more of:
i) a commercial impact of adjusting the attribute of the digital initiative, the commercial impact being indicated by the parameter value;
ii) a magnitude of organizational change from adjusting the attribute of the digital initiative, the magnitude being indicated by the parameter value; or
iii) a complexity of adjusting the attribute of the digital initiative, the complexity being indicated by the parameter value.

9. The method of claim 1, wherein data from the technology database comprises:
a listing of multiple digital initiatives in a digital library of initiatives; and
data from case studies about digital value adds that were realized from adjusting attributes of each digital initiative in the digital library of initiatives.

10. A computing system comprising:
one or more processing devices;
one or more non-transitory machine-readable storage devices for storing instructions that are executable by the one or more processing devices to cause performance of operations comprising:
accessing, by the computing system, a technology database that includes multiple digital initiatives and data describing each digital initiative of the multiple digital initiatives;
for each digital initiative in a subset of digital initiatives:
associating, by the computing system, the digital initiative to an indicator for an operation that relates to the digital initiative; and
determining, by a technology assessment model of the computing system, one or more impact metrics based on the indicator and the data from the technology database that describes the digital initiative, the one or more impact metrics each corresponding to implementation of the digital initiative; and
generating, by a data visualization model of the computing system, a data structure that is provided for output via a client device, the data structure including the one or more impact metrics and analytical data relating to implementation of the digital initiative.

11. The computing system of claim 10, wherein the operations further comprise:
determining, by the technology assessment model and based on execution of impact assessment logic, analytical data for implementing the digital initiative, wherein the analytical data comprises one or more of:
data indicating a digital value add to be realized from adjusting an attribute of the digital initiative; or
data indicating the digital value add to be realized from initially implementing the digital initiative.

12. The computing system of claim 10, wherein determining the one or more impact metrics, comprises:
executing, by the technology assessment model, one or more computational processes using data about the operation that relates to the digital initiative;
in response to executing, generating, by the technology assessment model, results data that quantifies an outcome of adjusting an attribute of the digital initiative; and
determining, by the technology assessment model, at least one impact metric based on the results data.

13. The computing system of claim 12, wherein:
the indicator is a key performance indicator for the operation, and
at least one impact metric of the one or more impact metrics indicates an operational impact to the operation that occurs from adjusting the attribute of the digital initiative.

14. The computing system of claim 12, wherein at least one impact metric of the one or more impact metrics indicates a cost of adjusting the attribute of the digital initiative, the cost corresponding to a digital value that is obtainable by adjusting the attribute of the digital initiative.

15. The computing system of claim 12, wherein the attribute of the digital initiative is an implementation maturity of the digital initiative, where the implementation maturity corresponds to an amount of digital value that is a realized from using the digital initiative.

16. The computing system of claim 12, wherein generating the data structure comprises:
generating mapping data that includes a prioritized listing of each digital initiative in the subset of digital initiatives, where each digital initiative is prioritized in the listing using a parameter value of at least one impact metric of the digital initiative.

17. The computing system of claim 16, wherein prioritization of each digital initiative is based on one or more of:
i) a commercial impact of adjusting the attribute of the digital initiative, the commercial impact being indicated by the parameter value;
ii) a magnitude of organizational change from adjusting the attribute of the digital initiative, the magnitude being indicated by the parameter value; or
iii) a complexity of adjusting the attribute of the digital initiative, the complexity being indicated by the parameter value.

18. The computing system of claim 10, wherein data from the technology database comprises:
a listing of multiple digital initiatives in a digital library of initiatives; and
data from case studies about digital value adds that were realized from adjusting attributes of each digital initiative in the digital library of initiatives.

19. One or more non-transitory machine-readable storage devices storing instructions that are executable by one or more processing devices to cause performance of operations comprising:
accessing, by a computing system, a technology database that includes a digital initiative and data describing the digital initiative;
associating, by the computing system, the digital initiative to an indicator for an operation that relates to the digital initiative;
determining, by a technology assessment model of the computing system, one or more impact metrics based on the indicator and the data from the technology database that describes the digital initiative, the one or more impact metrics each corresponding to implementation of the digital initiative;
generating, by a data visualization model of the computing system, a data structure that includes the one or more impact metrics and analytical data about implementation of the digital initiative; and
providing, by the computing system, the data structure for output at a display of a client device.

20. The one or more machine-readable storage devices of claim 19, wherein determining the one or more impact metrics, comprises:
executing, by the technology assessment model, one or more computational processes using data about the operation that relates to the digital initiative;
in response to executing, generating, by the technology assessment model, results data that quantifies an outcome of adjusting an attribute of the digital initiative; and
determining, by the technology assessment model, at least one impact metric based on the results data.
